(19) United States
(12) Patent Application Publication
(10) Pub. No.: US 2008/0177872 A1
(43) Pub. Date: Jul. 24, 2008

(54) MANAGING AGGREGATION AND SENDING OF COMMUNICATIONS

(76) Inventor: Darren E. Vengroff, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/938,211

(22) Filed: Nov. 9, 2007

Related U.S. Application Data
(60) Provisional application No. 60/865,381, filed on Nov. 10, 2006.

(51) Int. Cl. G06F 15/16

(52) U.S. Cl. 709/223

(57) ABSTRACT

Techniques are described for managing communications between client applications and remote recipients, such as remote Web services or other network services. In at least some situations, the techniques include providing client communication management systems on each of multiple client computing devices to manage communications being sent from and/or to one or more client applications executing on the client computing device, and/or providing server communication management systems on each of multiple server computing systems to manage communications being sent from and/or to one or more network services provided by the server computing system. A communication management system on a computing device or system may aggregate communications being sent to one or more remote recipients from one or more local applications or services, and then send a group of multiple aggregated communications together to the remote recipient when the communication management system determines that one or more predefined criteria are satisfied.

### CROSS REFERENCE TO RELATED APPLICATIONS

This application claims the benefit of provisional U.S. Patent Application No. 60/865,381, filed Nov. 10, 2006 and entitled “Asynchronous Batch Message Passing,” which is hereby incorporated by reference in its entirety.

### TECHNICAL FIELD

The following disclosure relates generally to managing communications between client applications and remote network services, such as to in some situations aggregate communications from multiple client applications to a single destination remote network service, and then send the aggregated communications together to the destination remote network service when appropriate.

### BACKGROUND

As the use of the Internet and the World Wide Web (“Web”) has become widespread, it is increasingly common for users to access and use various types of capabilities provided by remote computing systems over the Web. In addition to such user-initiated interactions, software programs on remote computing systems may also interact for various purposes and in various ways. For example, there is growing use of the Web to provide so-called “Web services,” which typically involve the programmatic interaction of remote applications to exchange information via defined APIs (“application program interfaces”). Web services allow heterogeneous applications and computers to interact, and may be defined and implemented using a variety of underlying protocols and techniques. For example, some Web service implementations return data in XML (“eXtensible Markup Language”) format using HTTP (“HyperText Transport Protocol”) in response to a Web service invocation request specified as a URI (“Uniform Resource Identifier”), such as a URL (“Uniform Resource Locator”) that includes a specified operation and one or more query parameters. Such URI-based invocation requests may, for example, be based on the use of XML over HTTP (e.g., as part of the REpresentational State Transfer, or “REST”, distributed interaction model that focuses on resources). In other implementations, additional underlying protocols are used for various purposes, such as SOAP (“Simple Object Access Protocol”) for standard message exchange, WSDL (“Web Services Description Language”) for description of service invocations, and UDDI (“Universal Description, Discovery, and Integration service”) for discovery of available services.

In some situations, Web services are divided into two types, generally referred to here as remote procedure call services and document-oriented services. In remote procedure call services, a client typically issues a request across a network and then waits for a response from the server. The wait may be blocking, non-blocking, or a hybrid (e.g., by using a future pointer which only causes blocking if it is de-referenced before the reply has arrived). Document-oriented services typically send a request with a variety of parameters (e.g., an HTTP GET or POST request), and expect a full document back (e.g., an HTML page or XML document).

While capabilities provided by Web services over networks to remote users and other clients have various benefits, various problems also exist. For example, in many situations, use of remote Web services by one or more client applications on a client computing device may cause one or more resources of the client computing device to be over-utilized, such as a battery for a mobile client device.

### BRIEF DESCRIPTION OF THE DRAWINGS

FIG. 1 is a network diagram illustrating an example embodiment in which clients and services interact via a network.

FIG. 2 is a block diagram illustrating example computing systems suitable for managing communications between client applications and remote network services.

FIG. 3 illustrates a flow diagram of an example embodiment of a Client Communication Aggregation Manager routine.

FIG. 4 illustrates a flow diagram of an example embodiment of a Server Communication Aggregation Manager routine.

### DETAILED DESCRIPTION

Techniques are described for, among other things, managing communications between client applications and remote recipients, such as remote network services. In at least some embodiments, the described techniques include providing client communication management systems on each of multiple client computing devices to manage communications being sent from and/or to one or more client applications executing on the client computing device. For example, for each of one or more remote network services, a client communication management system on a client computing device may aggregate communications being sent to the remote network service from the one or more client applications executing on the client computing device (e.g., communications that are requests for information and/or functionality from the remote network service and that are specified in accordance with defined APIs of the network services), and then send a group of multiple communications aggregated together to the remote network service (e.g., for a group of multiple aggregated communications that is specified in accordance with a defined API of a server communication management system on a server computing system providing the network service) when the client communication management system determines that one or more predefined criteria are satisfied. Alternatively, in some embodiments, a client communication management system on a client computing device may aggregate communications being sent from the one or more client applications executing on the client computing system to multiple network services provided by a particular server computing system. The client communication management system for a client computing device may similarly receive a group of multiple aggregated communications from one or more remote network services that are intended for the one or more client applications on the client computing device, extract the individual communications from the group, and forward each of the extracted communications to the particular client application that is the intended recipient of the communication—at least some of the communications received in the group may, for example, be responses to requests that were previously sent as at least some of the communications in one or more groups of multiple aggregated communications sent by the client communication system to the one or more remote network services. Additional details are included below related to techniques for the management of communications being sent from and/or to client applications executing on client computing devices, and in at least some embodiments, at least some of the techniques for the management of communications being sent from and/or to client applications executing on client computing devices are automatically performed by a Client Communication Aggregation Manager system that is one example embodiment of the client communication management system, as described in greater detail below.

Similarly, in at least some embodiments, the described techniques include providing server communication management systems on each of multiple server computing systems to manage communications being sent from and/or to one or more Web services or other network services provided by the server computing system. For example, for each of one or more remote client applications, a server communication management system on a server computing system may aggregate communications being sent to the remote client application from one or more network services provided by the server computing system (e.g., communications that are responses to requests previously received from the client application), and then send a group of multiple communications aggregated together to the remote client application (e.g., for a group of multiple aggregated communications that is specified in accordance with a defined API of a client communication management system on a client computing device on which the client application executes) when the server communication management system determines that one or more predefined criteria are satisfied. Alternatively, in some embodiments, a server communication management system on a server computing system may aggregate communications being sent from the one or more network services provided by the server computing system to multiple remote client applications executing on a particular client computing device. A server communication management system for a server computing system may similarly receive a group of multiple aggregated communications from one or more remote client applications that are intended for the one or more network services provided by the server computing system, extract the individual communications from the group, and forward each of the extracted communications to the particular network service that is the intended recipient of the communication—at least some of the communications received in the group may, for example, be requests for information or other functionality from the network service. Additional details are included below related to techniques for the management of communications being sent from and/or to network services provided by server computing systems, and in at least some embodiments, at least some of the techniques for the management of communications being sent from and/or to network services provided by server computing systems are automatically performed by a Server Communication Aggregation Manager system that is one example embodiment of a server communication management system, as described in greater detail below.

The described techniques may be used in various situations in various embodiments. For example, in at least some embodiments, the remote network service recipients of communications from clients are Web services that each provide one or more types of functionality to remote clients over one or more networks, while in other embodiments at least some of the recipients are other types of network services, or other types of recipients that are not network services. In addition, the client applications may have various forms, such as an applet (e.g., executing in a Web browser or other client-side execution environment), a stand-alone application program executing in memory of the client device, etc.

In addition, a group of aggregated communications may have various forms in various embodiments. In some embodiments, a group of multiple aggregated communications sent by a client communication management system may be stored together as part of a single request envelope, and a group of multiple aggregated communications sent by a server communication management system may be stored together as part of a single reply envelope. In this manner, multiple requests for a heterogeneous collection of network services may all be marshaled together into a single request envelope and sent to a server system that supports those network services, and multiple requests for a heterogeneous collection of client applications may all be marshaled together into a single reply envelope and sent to a client device that executes those client applications. For example, a reply envelope from a server system to a client device may contain responses to a number of service call requests, although not necessarily a collection of requests that were in any specific single request envelope. In various embodiments, the underlying transport procedure via which the envelopes are sent may be blocking or non-blocking. Additional details related to groups of aggregated communications are discussed in greater detail below.

The client computing devices may have various forms in various embodiments, including mobile client devices with wireless data connections (e.g., laptops and other portable computing systems; cell phones with data connections, such as smart phones; PDAs; etc.), and fixed-location client computing devices and systems (e.g., a desktop computing system, a home media server system, etc.). In addition, various types of networks, network connections and network transmission protocols may be used in various embodiments, including wired/cabled connections (e.g., Ethernet-based connections) and wireless connections (e.g., based on Wi-Fi, Bluetooth, WiMAX, CDMA, GPRS, EDGE, etc.), and using various network transmission protocols (e.g., TCP, UDP, HTTP, FTP, etc.). As one specific example, for a mobile client device that uses a wireless data connection, a client communication management system on the client device may aggregate outgoing communications into a group and send the group of communications together in order to provide various benefits for the mobile client device, such as to enhance the longevity of a battery of the client device (e.g., by preventing each outgoing communication from being individually sent, resulting in many short-lived network connections that consume more power than a relatively smaller number of longer-lived connections that in aggregate transfer the same amount of data), to address network connection characteristics (e.g., when the network connection has a relatively high latency and/or low bandwidth), etc.

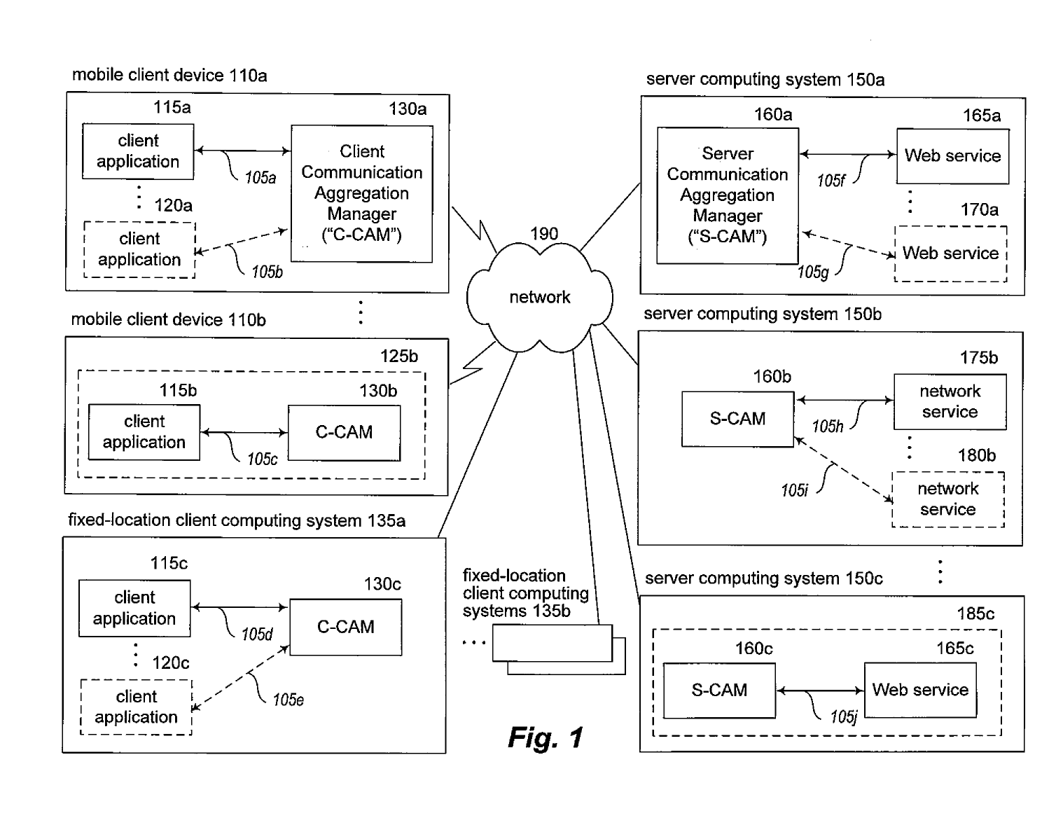

As previously noted, in at least some embodiments, communications between client applications and remote network services may be managed in various ways. FIG. 1 is a network diagram that illustrates an example embodiment in which various devices and computing systems interact over one or more networks, and in which communications between client applications and remote network services may be managed. For illustrative purposes, some embodiments are described below in which specific types of clients, network services, communications, and communication aggregations are used in specific manners. These examples are provided for illustrative purposes and are simplified for the sake of brevity, and it will be appreciated that the inventive techniques may be used in a wide variety of other situations, some of which are described below.

In particular, the illustrated example of FIG. 1 includes a number of example mobile client devices 110a-110b and fixed-location client computing systems 135a-135b—the mobile client devices and fixed-location client computing systems are referred to collectively as “client systems” with respect to FIG. 1. In FIG. 1, the client systems may each be communicating with one or more of a number of example server computing systems 150a-150c over one or more networks 190. In some embodiments, the network 190 may be a publicly accessible network of linked networks, possibly operated by various distinct parties, such as the Internet. In other embodiments, the network 190 may be a private network, such as, for example, a corporate or university network that is wholly or partially inaccessible to non-privileged computing systems and devices. In still other embodiments, the network 190 may include one or more private networks with access to and/or from the Internet. In some embodiments, mobile client devices 110a-110b may include, for example, cell phones, PDAs, smartphones, and/or other mobile computing devices with network communication capabilities.

In the example embodiment of FIG. 1, the client systems 110a-110b and 135a-135b each contain a Client Communication Aggregation Manager (“C-CAM”) system 130 and one or more executing client applications 115 and 120. The various client applications represent various types of applications that may perform interactions with remote network services (e.g., Web services, network services, etc.), such as interactions that include sending communications that request information and/or functionality from the remote services. As described in greater detail below, each illustrated C-CAM system 130 executes on a client system to manage communications between one or more client applications executing on that client system and one or more remote Web services or other network services. For example, the example mobile client device 110a includes a C-CAM system 130a, a first client application 115a, and optionally one or more other client applications 120a. The client application 115a initiates one or more communications 105a to one or more Web services 165 or 170 and/or to one or more other network services 175 or 180 (e.g., request communications to obtain information and/or functionality), which in the illustrated embodiment are received by the intermediate C-CAM system 130a. The optional other client applications 120a may each optionally initiate one or more communications 105b in a similar manner to one or more Web services 165 or 170 and/or to one or more other network services 175 or 180, which are each similarly received by the C-CAM system 130a in the illustrated embodiment. Furthermore, the communications 105a may include one or more reply communications sent back to the client application 115a via the C-CAM system 130a from one or more Web services or other network services to which the outgoing communications 105a from the client application 115a were sent, and the communications 105b may similarly include one or more such reply communications.

The illustrated client applications may take various forms in various embodiments. For example, in the examples shown with respect to mobile client device 110a and fixed-location client computing system 135a, the client applications 115 and 120 executing on those client systems are separate from the C-CAM systems 130 executing on those client systems. In particular, with respect to client system 110a, the client application 115a may in some embodiments be unaware of the existence of the C-CAM system 130a and/or that the C-CAM system 130a receives the outgoing communications 105a sent by the client application 115a (e.g., if the C-CAM system intercepts the outgoing communications before they leave the client device 110a, such as by operating in conjunction with a network interface, not shown, for the network 190), while in other embodiments the client application 115a may be configured or otherwise directed to route communications to the Web services or other network services via the C-CAM system 130a. In other embodiments, a client application and a C-CAM system on a client system may be integrated together as part of a single executing software application, such as illustrated by optional integrated application 125b on mobile client device 110b. In addition, while not illustrated here, in some embodiments, a particular C-CAM system may manage communications for multiple distinct client systems, and/or may execute on one or more computing systems that are distinct from one or more client systems whose communications are managed by the C-CAM system.

Each of the example server computing systems 150a-150c of FIG. 1 includes a Server Communication Aggregation Manager (“S-CAM”) system 160 and one or more of various types of services that provide functionality to remote client applications (e.g., one or more Web services 165 and 170, and/or other network services 175 and 180). For example, the various Web services and/or other network services may receive request communications from remote client applications for information and/or functionality, and respond with reply communications to the remote client applications. As described in greater detail below, each illustrated S-CAM system 160 executes on a server computing system to manage communications between one or more Web services or other network services provided by that server computing system and one or more remote client applications. For example, the example server computing system 150a includes a S-CAM system 160a, a first Web service 165a, and optionally one or more other Web services 170a. The Web service 165a initiates one or more communications 105f to one or more client applications 115 or 120 (e.g., reply communications to previously received requests to obtain information and/or functionality), which in the illustrated embodiment are received by the intermediate S-CAM system 160a. The optional other Web services 170a may each optionally initiate one or more communications 105g in a similar manner to one or more client applications 115 or 120, which are each similarly received by the S-CAM system 160a in the illustrated embodiment. Furthermore, the communications 105f may include one or more initial request communications received from one or more client applications 115 or 120 via the S-CAM system 160a, such as to prompt corresponding outgoing reply communications to those client applications, and the communications 105g may similarly include one or more such incoming request communications.

The illustrated Web services and other network services may take various forms in various embodiments. For example, in the examples shown with respect to server computing systems 150a and 150b, the Web services 165a and 170a and other network services 175b and 180b provided by those server computing systems are separate from the s-CAM systems 160 executing on those server computing systems. In particular, with respect to server computing system 150a, the Web service 165a may in some embodiments be unaware of the existence of the S-CAM system 160a and/or that the S-CAM system 160a receives the outgoing communications 105f sent by the Web service 165a (e.g., if the s-CAM system intercepts the outgoing communications before they leave the server computing system 150a, such as by operating in conjunction with a network interface, not shown, for the network 190), while in other embodiments the Web service 165a may be configured or otherwise directed to route communications to remote client applications via the S-CAM system 160a. In other embodiments, a Web service and a S-CAM system on a server computing system may be integrated together as part of a single executing software application, such as illustrated by optional integrated application 185c on server computing system 150c. In addition, while not illustrated here, in some embodiments, a particular S-CAM system may manage communications for multiple distinct server computing systems, and/or may execute on one or more computing systems that are distinct from one or more server computing systems whose communications are managed by the S-CAM system.

In the illustrated embodiment, each of the C-CAM systems 130a-130c and S-CAM systems 150a-150c performs operations related to managing communications on behalf of various client applications and various network services, such as by aggregating multiple outgoing communications to a recipient or group of recipients (e.g., multiple recipients provided by or executing on a single computing device or system) into a single communication envelope, and by extracting multiple incoming communications that are aggregated into a single received communication envelope so that the incoming communications may be forwarded to the intended recipients. In some embodiments, communication envelopes may contain aggregated communications intended for one or more recipients from multiple senders, while in other embodiments, a communication envelope may aggregate communications intended for multiple recipients from one or more senders. In addition, in at least some embodiments, a communication envelope may contain multiple communications that consist of various types of communication data, including textual data (e.g., XML document data), binary data, and/or various other data representations and formats.

With respect to FIG. 1, each of the illustrated C-CAM systems 130a-130c may aggregate multiple communications that are sent from one or more client applications and intended for one or more remote network service recipients into a single request envelope, and at a time determined by the C-CAM system (e.g., based upon various criteria and/or the occurrence of various events, as described elsewhere), send the request envelope to an S-CAM system that is managing communications for the one or more remote network service recipients. In such embodiments, after the S-CAM system receives the request envelope, the S-CAM system may extract from the envelope each of the multiple communications, and provide each extracted communication to the intended remote network service recipient.

In some embodiments, a C-CAM system on a client system may aggregate all client application communications during a period of time into one request envelope, such as when all client application communications are intended for one or more remote network service recipients accessible via a particular target S-CAM system for a particular server computing system. In such embodiments, when it is determined to send the one request envelope to the particular target S-CAM system, the envelope may be sent to the particular target S-CAM system, and a new request envelope may be provided by the C-CAM system to aggregate new communications intended for the one or more remote network service recipients, such that the new request envelope containing new communications may be sent to the particular target S-CAM system at a later determined time. In other embodiments, multiple request envelopes may be accumulated simultaneously, such as in cases where at least some client communications are intended for remote network service recipients accessible via one or more different S-CAM systems (e.g., one or more different S-CAM systems provided by a single server computing system, and/or multiple different S-CAM systems provided by multiple different server computing systems) —in such cases, client communications intended for remote network service recipients accessible via a particular target S-CAM system are aggregated into a request envelope intended for that target S-CAM system, and communications intended for remote network service recipients accessible via another particular target S-CAM system are aggregated into another request envelope intended for that other particular target S-CAM system.

Furthermore, in some embodiments, when it is determined that at least one request envelope targeted for a particular S-CAM system is ready for sending, the at least one determined request envelope will be sent to the targeted S-CAM system, and new client communications intended for remote network service recipients associated with that particular target S-CAM system will be aggregated into a new request envelope for sending to the target S-CAM system at a future determined time. In other embodiments, when it is determined that at least one request envelope targeted for a particular S-CAM system is ready for sending, all request envelopes intended for all target S-CAM systems may be sent at the same time, such that all new client communications will be aggregated into appropriate new request envelopes for sending at a future determined time. In at least some embodiments, when it is determined that a request envelope targeted for a particular S-CAM system is ready for sending, the request envelope may be stored for sending to the target S-CAM system at a later determined time (e.g., such as a time determined based on a maximum number of stored request envelopes and/or other criteria), and new client application communications intended for remote network service recipients accessible via the particular target S-CAM system will be accumulated and aggregated in a new request envelope targeted for that S-CAM system.

In various embodiments, a C-CAM system may use various dispatch criteria to determine when to send a request envelope. For example, such dispatch criteria may include the current size of one or more envelopes containing aggregated communication data, the rate of growth of one or more envelopes, the amount of time that has passed since a prior envelope has been sent, quality of service considerations (e.g., such as to minimize the amount of time that a particular client application or network service “starves” while waiting for data), etc. In addition, other dispatch criteria may include one or more characteristics of the sending and/or receiving computing system (e.g., disk space, memory size, processor speed, bandwidth, power usage requirements, etc.). For example, devices that are battery-powered (e.g., various mobile devices including PDAs, cell phones, smartphones, etc.) may consume more battery power by initiating many short-lived network connections than by initiating a relatively smaller number of longer-lived connections. In some embodiments the occurrence of one or more various events may trigger a C-CAM system to send a request envelope, such as events related to the passage of time (e.g., envelopes sent according to the expiration of a period of time) and/or specific requests from a sender or receiver (e.g., a client application or network service notifies the C-CAM system that data must be sent/received, etc.).

In some embodiments, similar to the techniques described for C-CAM systems, the illustrated S-CAM systems 160a-160c may each aggregate multiple outgoing communications intended for one or more remote client application recipients into a single reply envelope (e.g., using techniques similar to those described with respect to C-CAM systems and request envelopes), and at a time determined by the S-CAM system (e.g., based on various criteria and/or the occurrence of events similar to those as described elsewhere for C-CAM systems), send the reply envelope to a C-CAM system having access to the one or more remote client application recipients (e.g., such as remote client application recipients executing on the same client system as the C-CAM system). In addition, in such embodiments, after the C-CAM system having access to the one or more remote client application recipients receives the reply envelope, the C-CAM system may extract from the envelope each of the multiple communications, and provide each extracted communication to its intended client recipient. It will be appreciated that reply envelopes may be accumulated, such as one or more at a time, using techniques similar to those already described with respect to illustrated embodiments of the C-CAM systems (e.g., techniques related to aggregating communications into one or more reply envelopes, targeting reply envelopes for particular client systems associated with particular client applications, sending one or more reply envelopes at a time, etc.).

As an illustrative example of some of the described techniques, illustrated example client application 115b may initiate outgoing request communications to Web service 165a and to one or more Web services 170a provided by server computing system 150a. Using at least some of the described techniques, C-CAM system 130b may aggregate into a single request envelope multiple communications from client application 115b that are each intended for one of the various Web services 165a and 170a, with the communications being received by the C-CAM system 130b via interactions 105c. At a determined time, the C-CAM system 130b sends the request envelope containing the aggregated multiple communications to S-CAM system 160a over the one or more networks 190. After receiving the request envelope, S-CAM system 160a extracts each of the multiple included communications, and forwards each of the extracted communications to its intended recipient Web service 165a or 170a via interactions 105f and 105g, respectively.

As another illustrative example, mobile client 110a may contain multiple client applications, including client application 115a and one or more client applications 120a, which may each initiate outgoing request communications to Web service 165a and to one or more Web services 170a provided by server computing system 150a. In this example, using at least some of the described techniques, the C-CAM system 130a may aggregate into a single request envelope multiple communications from multiple of the client applications 115a and 120a that are each intended for one of the various Web services 165a and 170a, with the communications being received by the C-CAM system 130a via interactions 105a and/or 105b. At a determined time, the C-CAM system 130a then sends the request envelope to S-CAM system 160a over the one or more networks 190. After receiving the request envelope, S-CAM system 160a extracts each of the multiple included communications, and forwards each of the extracted communications to its intended recipient Web service 165a or 170a via interactions 105f and 105g, respectively.

In some situations, client applications may receive reply communications from network services to which the client applications sent request communications, and/or may otherwise receive communications from network services. In situations in which one or more network services provided by a server computing system respond to requests received from one or more client applications executing on a client system, a S-CAM system for the server computing system may receive reply communications from the one or more network services for the one or more client applications, and then aggregate those reply communications into a reply envelope. At a determined time, the S-CAM system then sends the reply envelope containing the aggregated multiple communications to a C-CAM system for the client system. For example, continuing the prior example, one or more of the various Web services 165a and 170a provided by server computing system 150a may initiate communications intended for one or more client applications 115a and 120a executing on mobile client device 110a, such as with at least some of the initiated communications being in response to corresponding request communications previously received from the one or more client applications.

The examples described with respect to FIG. 1 are provided for illustrative purposes and are simplified for the sake of brevity, and a variety of additional types of actions may be alternatively or additionally taken. For example, although client applications on mobile client device 110a have been described as communicating with Web services provided by server computing system 150a, one or more of the client applications 115a and 120a may communicate using at least some of the described techniques with one or more other network services provided by one or more other server computing systems, such as network services 175b, 180b, and 165c provided by server computing systems 150b and 150c. Similarly, one or more of the client applications 115b, 115c and 120c may each communicate with one or more network services provided by one or more of the server computing systems 150.

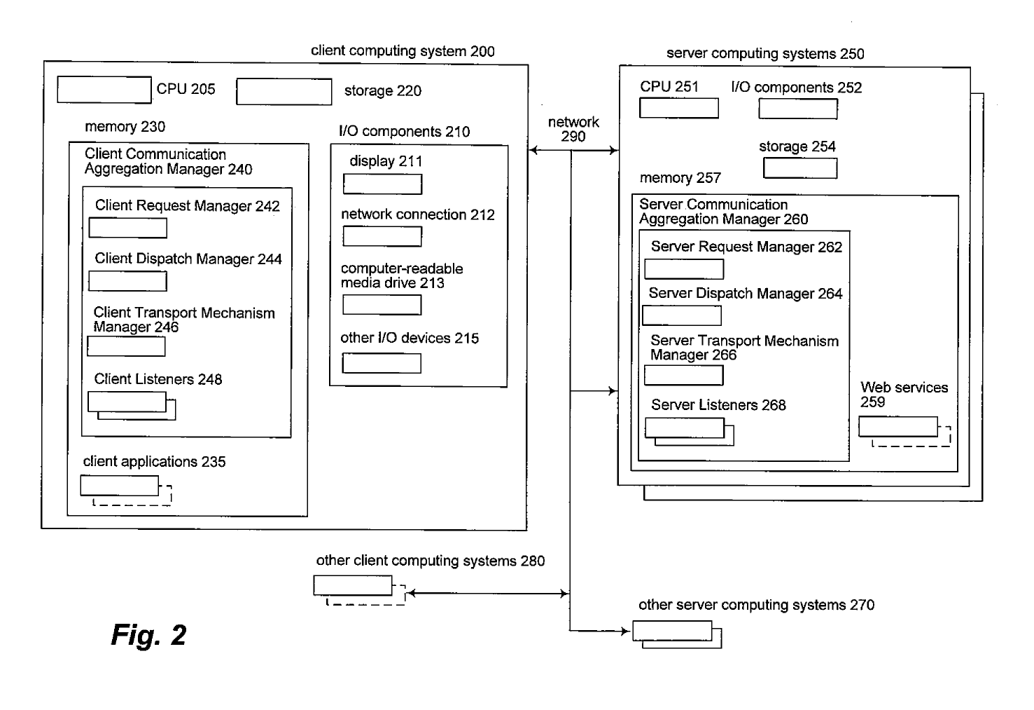

FIG. 2 illustrates computing systems suitable for performing techniques for managing communications between various client applications and network services. In particular, FIG. 2 illustrates a client computing system 200 suitable for executing an embodiment of a Client Communication Aggregation Manager system 240, and a server computing system 250 suitable for executing an embodiment of a Server Communication Aggregation Manager system 260, as well as various other client computing systems 280 and server computing systems 270. In the illustrated embodiment, the client computing system 200 has components that include a CPU 205, various I/O components 210, storage 220, and memory 230, with the I/O components including a display 211, a network connection 212, a computer-readable media drive 213, and other I/O devices 215 (e.g., a mouse, keyboard, speakers, etc.). The server computing system 250 has components that include a CPU 251, various I/O components 252, storage 254, and memory 257, although particular I/O components are not shown. While the client computing systems 280 and server computing systems 270 are not illustrated with components, they may each have components and software systems similar to those of client computing system 200 and server computing system 250, respectively.

In the illustrated embodiment, a Client Communication Aggregation Manager system 240 is executing in memory 230 of the client computing system 200, and it manages communications to and from one or more client applications 235 executing in memory 230. The client applications 235 may initiate outgoing request communications to obtain functionality from remote network services on the server computing systems 250 and 270, such as one or more Web services 259 executing in memory 257 of the server computing system 250. The system 240 receives the outgoing request communications, aggregates them into one or more request envelopes, and sends them to one or more of the server computing systems 250 and 270 over the network connection 290 (e.g., via the Internet and/or the World Wide Web, a cellular network, etc.). A Server Communication Aggregation Manager system on each of those server computing systems (such as system 260 executing in memory 257 of server computing system 250) receives the request envelopes, extracts the request communications, and forwards the extracted communications to the intended recipient Web services or other network services.

In the illustrated embodiment, the Client Communication Aggregation Manager system 240 includes a Client Request Manager component 242, a Client Dispatch Manager component 244, a Client Transport Mechanism Manager component 246, and one or more Client Listener components 248. The components may be implemented in various manners in various embodiments, including as code libraries. The Client Request Manager component 242 receives outgoing request communications from the client applications 235 that are intended for remote network services on the server computing systems 250 and 270, such as with each communication having a client identifier to identify the sender and/or having a service identifier to identify the intended recipient, and optionally including a payload of data (e.g., in binary, XML, or other appropriate format) for use by the server to process the request. The component 242 then aggregates the communications for one or more network services provided by a single server computing system into a single request envelope for that server computing system, such as by creating a new or identifying an existing request envelope data structure associated with the one or more network services provided by the single server computing system, and by storing the request communications in the request envelope data structure (e.g., by appending, inserting, pushing, attaching, etc. such data onto a data structure such as an array, linked list, stack, queue, or other type of data structure). In at least some embodiments, the multiple aggregated communications of a request envelope may included payloads of multiple types. The data associated with a communication may be of various types in various embodiments, including textual data, binary data, and/or other data formats.

The Client Dispatch Manager component 244 examines pending request envelopes at various times (e.g., prior to or following the addition of communications data into a request envelope, and/or at a regular or semi-regular interval of time, etc.), and determines whether to select one or more request envelopes to be sent to their recipients, such as based on criteria or other factors as discussed elsewhere. In some embodiments and situations, the component 244 may periodically determine to dispatch an empty request envelope to a server computing system, such as to ensure that any communications sent from a network service provided by the server computing system but being delayed while aggregating other communications be sent to the system 240 in a timely manner. In addition, in at least some embodiments in which a client application is multithreaded, appropriate mutex's or other standard synchronization mechanisms may be used so that clients are able to deliver their requests to a valid envelope. The Client Transport Mechanism Manager component 246 optionally converts the selected request envelopes containing aggregated communications into a data format suitable for sending across a network (e.g., such as by encoding, marshalling or serializing) and/or into a format corresponding to a network protocol to be used to send the aggregated communication, and then sends the selected envelopes across the network to the one or more appropriate destination server computing systems.

In some embodiments, the Client Communication Aggregation Manager system 240 may receive reply envelopes from server computing systems that contain multiple aggregated communications intended for one or more of the client applications 235, whether in addition to or instead of sending request envelopes to server computing systems. In such embodiments, the Client Transport Mechanism Manager component 246 receives such reply envelopes, and in at least some embodiments may convert the received reply envelopes into a format suitable for processing by the Client Request Manager component 242 (e.g., such as by decoding, unmarshalling or deserializing received reply envelopes). Once a reply envelope has been converted into a suitable format, the Client Request Manager component 242 then extracts each communication from the reply envelope, identifies the intended client application to receive the communication (e.g., based on assistance from one or more corresponding client listeners), and provides the communication to the identified client application. For example, the illustrated Client Listener components 248 may provide functionality such that the client applications 235 may each register to receive communications from one or more remote network services (e.g., such as at a time when the client applications initiate communications with the one or more network services by interacting with the Client Request Manager component 242), with each listener component 248 able to recognize incoming communications that are intended for one or more particular client applications (e.g., based on a name associated with a request communication by a client application, unique identifiers, named references, URLs, etc., such as may be provided by the client application, the Client Request Manager component, or another entity). In addition, in at least some embodiments, some network services may not initiate reply communications to request communications received from client applications (e.g., if the network services act as data collection services), and some network services may initiate communications to client applications that are not responses to any communications received from the client applications.

In the illustrated embodiment, a Server Communication Aggregation Manager system 260 is executing in memory 257 of the server computing system 250, and it manages communications to and from one or more Web services 259 executing in memory 257. The Web services 259 may initiate outgoing communications to client applications, such as in response to request communications received from the client applications. The system 260 receives the outgoing communications, aggregates them into one or more reply envelopes, and sends them to one or more of the client computing systems 200 and 280 over the network connection 290 (e.g., via the Internet and/or the World Wide Web, a cellular network, etc.). A Client Communication Aggregation Manager system on each of those client computing systems (such as system 240 executing in memory 230 of client computing system 200) receives the reply envelopes, extracts the included communications, and forwards the extracted communications to the intended recipient client applications.

In the illustrated embodiment, the Server Communication Aggregation Manager system 260 includes a Server Request Manager component 262, a Server Dispatch Manager component 264, a Server Transport Server Manager component 266, and one or more Server Listener components 268. The components 262-268, in at least some embodiments, provide similar functionality, use similar techniques, and may be implemented in similar manners as described in relation to the components 242-248 of the system 240. For example, in some embodiments, the Server Request Manager component 262 receives outgoing communications from the Web services 259 that are intended for one or more client applications on client computing systems 200 and 280. The component 262 then aggregates the communications for one or more client applications executing on a client computing system into a single reply envelope intended for that client computing system. The Server Dispatch Manager component 264 examines pending reply envelopes at various times (e.g., prior to or following the addition of communications data into a reply envelope, and/or at a regular or semi-regular interval of time, etc.), and determines whether to select one or more reply envelopes to be sent to their recipients, such as based on criteria or other factors as discussed elsewhere. In some embodiments and situations, the component 264 may periodically determine to dispatch an empty reply envelope to a client computing system, such as to ensure that any communications sent from a client application executing on the client computing system but being delayed while aggregating other communications be sent to the system 260 in a timely manner. In addition, in at least some embodiments in which a Web service or other network service is multithreaded, appropriate mutex's or other standard synchronization mechanisms may be used so that server are able to deliver their responses to a valid envelope. The Server Transport Mechanism Manager component 266 optionally converts the selected reply envelopes containing aggregated communications into a data format suitable for sending across a network (e.g., such as by encoding, marshalling or serializing) and/or into a format corresponding to a network protocol to be used to send the aggregated communication, and then sends the selected envelopes across the network to the one or more appropriate destination client computing systems.

In some embodiments, the Server Communication Aggregation Manager system 260 may receive request envelopes from client computing systems containing communications intended for network services (e.g., Web services 259). In such embodiments, the Server Transport Mechanism Manager component 266 receives such request envelopes, and in at least some embodiments may convert the received request envelopes into a format suitable for processing by the Server Request Manager component 262 (e.g., such as by decoding, unmarshalling or deserializing received request envelopes). Once a request envelope has been converted into a suitable format, the Server Request Manager component then extracts each communication from the request envelope, identifies the intended network service to receive the communication (e.g., based on assistance from one or more corresponding server listeners), and provides the communication to the identified network service. For example, the illustrated Server Listener components 268 may each provide functionality such that the network services 259 may each register to receive communications from one or more client applications 235 and such that the Server Request Manager component may identify intended network services and provide communications to the identified intended network services. In various embodiments, network services may be identifiable by client applications and the Server Request Manager component by one or more various types of identifiers (e.g., unique identifiers, URLs, etc.).

Those skilled in the art will appreciate that the computing systems 200, 250, 270 and 280 are merely illustrative and are not intended to limit the scope of the embodiments of the present disclosure. For example, the software systems 240 and/or 260 may instead be executed by multiple interacting computing systems or devices, and various of the computing systems may be connected to other devices that are not illustrated, including through one or more networks such as the Internet, via the World Wide Web (“Web”), or other electronic communications network (e.g., a cellular based network, public switched telephone network, etc.). More generally, a “client” or “server” computing system or computing device may comprise any combination of hardware or software that can interact in the indicated manners, including (without limitation) desktop or other computers, network devices, smartphones, PDAs, cellphones, wireless phones, pagers, electronic organizers, Internet appliances, television-based systems (e.g., using set-top boxes and/or personal/digital video recorders), game consoles, media players and various other consumer products that include appropriate inter-communication capabilities. In addition, the functionality provided by the systems 240 and/or 260 may in some embodiments be distributed in additional or less components than is shown. Similarly, in some embodiments, some of the functionality of the systems 240 and/or 260 may not be provided, and/or other additional functionality may be available.

Those skilled in the art will also appreciate that, while various items are discussed or illustrated as being stored in memory or on storage while being used, these items or portions of them may be transferred between memory and other storage devices for purposes of memory management and data integrity. Alternatively, in other embodiments some or all of the software systems or components of those systems may execute in memory on another device and communicate with the illustrated computing systems via inter-computer communication. Furthermore, in some embodiments, some or all of the systems and/or components may be implemented or provided in other manners, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the systems, components and/or data structures may also be stored (e.g., as executable or other machine-readable software instructions or structured data) on a computer-readable medium, such as a hard disk, a memory, a network, or a portable media article to be read by an appropriate drive or via an appropriate connection. The systems, components and data structures may also be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

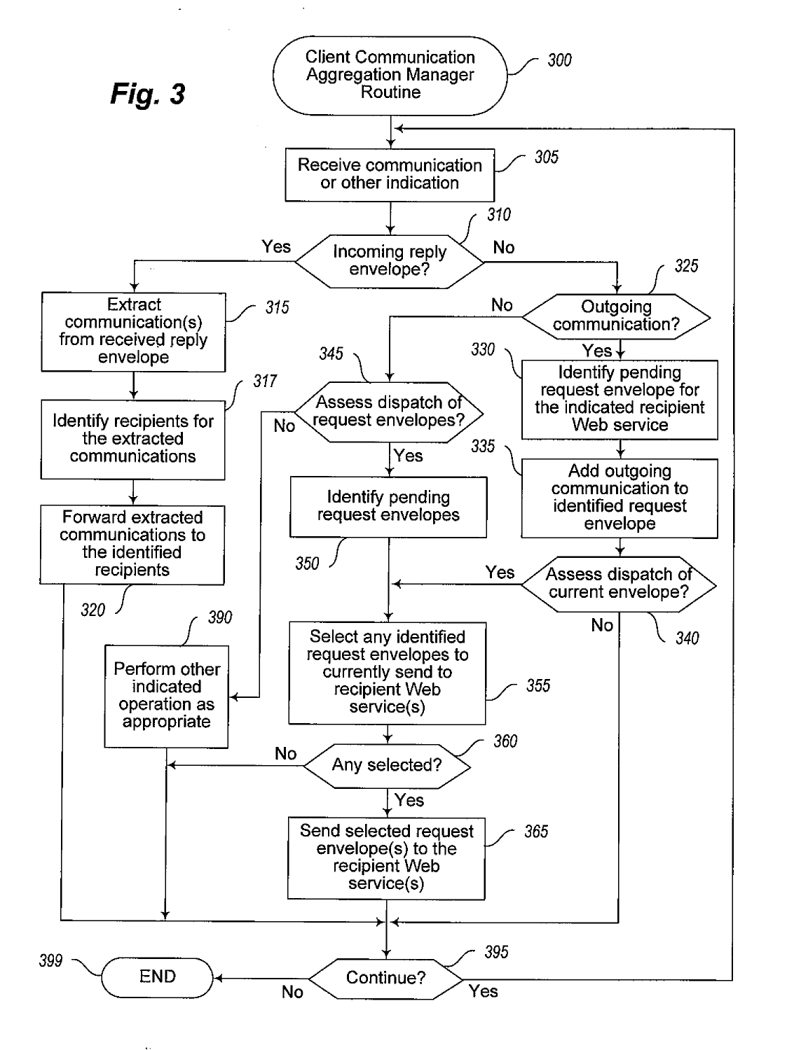

FIG. 3 is a flow diagram of an example embodiment of a Client Communication Aggregation Manager routine 300. The routine may be provided by, for example, execution of an embodiment of the Client Communication Aggregation Manager system 240 of FIG. 2 and/or of one of the C-CAM systems 130 of FIG. 1 on or for a client computing device, such as to manage communications being sent from one or more executing client applications on the client computing device to one or more remote network services. In the illustrated embodiment, outgoing communications are being sent to particular recipient Web services to request information and/or functionality from them, although in other embodiments other types of outgoing communications may be handled in a similar manner. In addition, in the illustrated embodiment, outgoing communications are aggregated together in request envelopes and incoming communications may be aggregated together in reply envelopes, although in other embodiments other types of request communication aggregation mechanisms and/or reply communication aggregation mechanisms may be used.

The illustrated embodiment of the routine begins at block 305, where an indication is received of one or more communications or of an instruction. The routine continues to block 310 to determine whether a reply envelope was received in block 305 from a remote server computing system. If so, the routine continues to block 315 to analyze the reply envelope and extract one or more reply communications from it, such as reply communications sent by one or more Web services provided by one or more Web services provided by the server computing system. In block 317, the routine then identifies the intended client recipient on the client computing device for each of the extracted communications. A recipient for a communication may be identified in various ways, such as based on a recipient identifier included as part of the communication, based on contents of the communication, etc. In addition, the client recipients may have various forms in various embodiments, such as to each be a distinct client application executing on the client computing device, or instead to have multiple distinct client recipients within a single executing client application (e.g., for a multi-threaded application in which multiple threads each execute an independent group of code that can send and/or receive communications independently of the other threads, or based on multiple sockets or other communication mechanisms created by a single client application). After block 317, the routine continues to block 320 to forward the extracted communications to the identified client recipients, such as via shared memory on the client computing device or another mechanism internal to the client computing device.

If it was instead determined in block 310 that the indication received in block 305 was not an incoming reply envelope, the routine continues instead to block 325 to determine whether an outgoing communication sent from a client application to an intended remote Web service recipient was received. If so, the routine continues to block 330 to identify a request envelope that corresponds to the indicated recipient Web service, such as a request envelope specific to that indicated recipient Web service, or instead a request envelope that corresponds to a group of multiple Web services that include the indicated recipient Web service (e.g., to a server computing system that provides the multiple Web services). The identified request envelope may be a pending request envelope that already includes one or more communications (e.g., communications from the same client application that sent the current outgoing communication and/or from one or more other client applications on the client computing device). Alternatively, if a pending request envelope does not currently exist for the indicated recipient Web service (e.g., based on the current communication being a first communication to the indicated recipient Web service, or instead based on a prior request envelope for the indicated recipient Web service having been recently dispatched to that Web service), the routine in block 330 creates the identified request envelope for the recipient Web service.

In the illustrated embodiment, after block 330, the routine continues to block 335 to add the communication received in block 305 to the identified request envelope, and then continues to block 340 to determine whether to currently assess whether to dispatch the current request envelope to its recipient. For example, in some embodiments, the routine may determine to assess whether to dispatch a request envelope at various times, such as after each communication is added to the request envelope, or instead periodically. Alternatively, in some embodiments, the routine may determine to assess whether to dispatch a request envelope based on another type of triggering event, such as based on current conditions satisfying one or more predefined dispatch determination initiation criteria (e.g., to reflect a current battery status of the client computing device or information about other current resource usage of the client computing device; to reflect characteristics of a transmission medium over which communications are sent, such as signal strength related to a wireless connection, or network operational characteristics such as current bandwidth availability and/or network latency, etc.).

If it was instead determined in block 325 that the indication received in block 305 was not an outgoing communication, the routine continues instead to block 345 to determine whether an instruction was received in block 305 to initiate an assessment of whether to dispatch one or more current request envelopes to their recipients, such as based on expiration of a timer to trigger a periodic assessment, or based on an indication of other current conditions that satisfy predefined dispatch determination initiation criteria. If so, the routine continues to block 350 to identify all of the pending request envelopes for the client computing device (e.g., multiple request envelopes that each correspond to one of multiple recipient Web services provided by multiple server computing systems), although in other embodiments only a subset of the pending request envelopes may be considered (e.g., only request envelopes of a particular type, only request envelopes corresponding to particular recipients or types of recipients, only request envelopes that are created before or after an indicated time, etc.). After block 350, or if it was determined in block 340 to currently assess the dispatch of the request envelope identified in block 330, the routine continues to block 355 to determine whether it is appropriate to currently send any of the request envelopes identified in blocks 330 or 350 to their recipients, and if so to select those request envelopes for which it is determined to be appropriate. As discussed in greater detail elsewhere, a determination of whether it is appropriate to send a particular request envelope at a particular time may be made in a variety of ways in various embodiments, such as based on whether current conditions satisfy one or more predefined dispatch criteria specific to the particular request envelope and/or for use with all request envelopes. Such predefined dispatch criteria may, for example, be based on information about a request envelope (e.g., the amount of data in the envelope; the number of communications in the envelope; the length of time that the envelope has been pending, such as since a prior envelope to the same recipient was sent; etc.) and/or on other current conditions related to the client computing device, recipient Web services, and/or one or more transmission mediums to be used for sending one or more request envelopes to one or more recipients. In the illustrated embodiment, the routine continues to block 360 to determine whether any of the identified request envelopes were selected, and if so continues to block 365 to send each of the selected request envelopes to the recipient Web service for that request envelope.

If it was instead determined in block 345 that the indication received in block 305 was not an instruction to currently assess whether to dispatch one or more pending request envelopes, the routine continues instead to block 390 to perform one or more other indicated operations as appropriate. For example, in some embodiments, the routine may receive incoming communications that are not reply envelopes, such as an individual communication being sent to a specified client application, and if so the routine may forward that received communication to the indicated recipient. Similarly, in some embodiments, at least some outgoing communications may be sent to at least some indicated recipients without aggregating the outgoing communications in a request envelope, such as if the indicated recipient does not have a Server Communication Aggregation Manager system to de-aggregate such a request envelope, or instead based on other information about the recipient, communication, and/or the transmission medium to be used for sending the communication. If so, such a received outgoing communication may be forwarded directly to the indicated recipient without aggregation in a request envelope. A variety of other actions may similarly be taken in at least some embodiments with respect to block 390.

After blocks 320, 365, or 390, of if it is instead determined in block 340 not to currently assess whether to dispatch the current request envelope, or in block 360 that none of the identified request envelopes were selected, the routine continues to block 395 to determine whether to continue, such as to handle additional incoming and/or outgoing communications for the client computing device. If so, the routine returns to block 305, and if not continues to block 399 and ends.

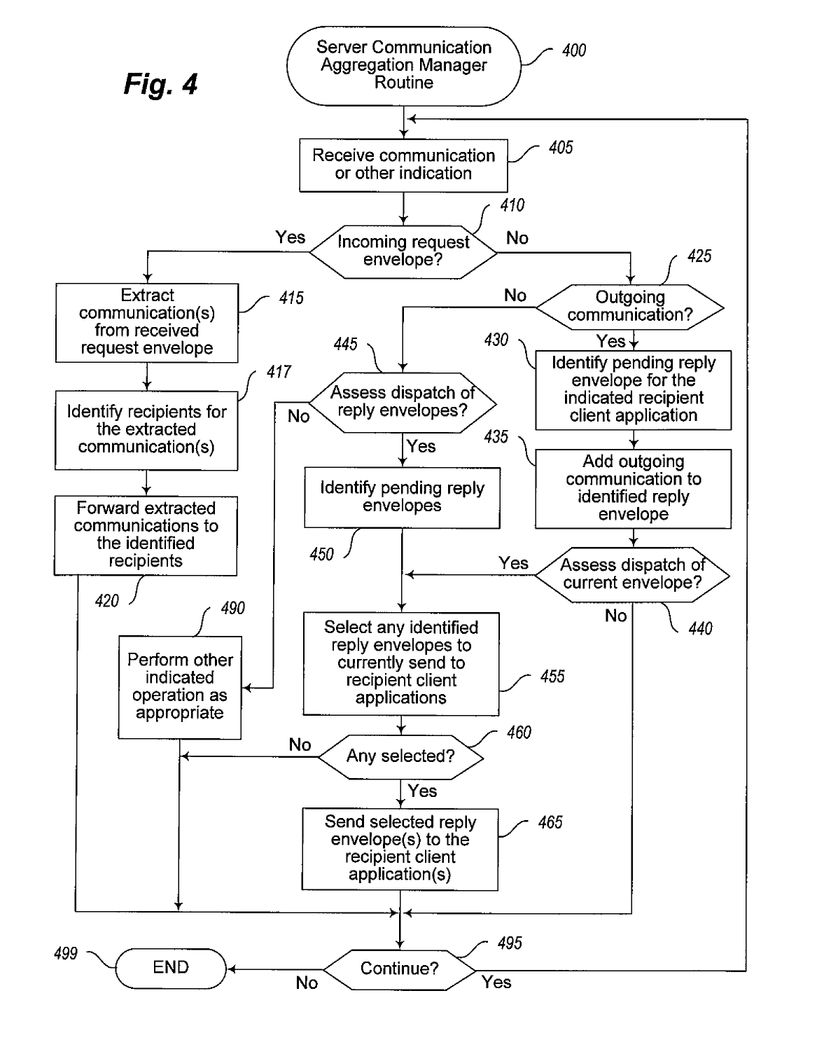

FIG. 4 is a flow diagram of an example embodiment of a Server Communication Aggregation Manager routine 400. The routine may be provided by, for example, execution of an embodiment of the Server Communication Aggregation Manager system 260 of FIG. 2 and/or of one of the S-CAM systems 160 of FIG. 1 on or for a server computing system, such as to manage communications being sent from one or more executing Web services provided by the server computing system to one or more remote client applications. In the illustrated embodiment, outgoing communications are being sent to particular client applications to provide information and/or functionality to them in response to requests from them, although in other embodiments other types of outgoing communications may be handled in a similar manner. In addition, in the illustrated embodiment, outgoing communications are aggregated together in reply envelopes and incoming communications may be aggregated together in request envelopes, although in other embodiments other types of reply communication aggregation mechanisms and/or request communication aggregation mechanisms may be used.

The illustrated embodiment of the routine begins at block 405, where an indication is received of one or more communications or of an instruction. The routine continues to block 410 to determine whether a request envelope was received in block 405 from a remote client computing device. If so, the routine continues to block 415 to analyze the request envelope and extract one or more request communications from it, such as request communications sent by one or more client applications executing on the client computing device. In block 417, the routine then identifies the intended server recipient on the server computing system (e.g., a Web service provided by the server computing system) for each of the extracted communications. A recipient for a communication may be identified in various ways, such as based on a recipient identifier included as part of the communication, based on contents of the communication, etc. In addition, the server recipients may have various forms in various embodiments, such as to each be a distinct Web service executing on or otherwise provided by the server computing system, or instead to have multiple distinct server recipients as part of a single Web service or other network service (e.g., for a multi-threaded application in which multiple threads each execute an independent group of code that can send and/or receive communications independently of the other threads, or based on multiple sockets or other communication mechanisms created by a single network service). After block 417, the routine continues to block 420 to forward the extracted communications to the identified server recipients, such as via shared memory on the server computing system or another mechanism internal to the server computing system.

If it was instead determined in block 410 that the indication received in block 405 was not an incoming request envelope, the routine continues instead to block 425 to determine whether an outgoing communication sent from a Web service to an intended remote client application was received. If so, the routine continues to block 430 to identify a reply envelope that corresponds to the indicated recipient client application, such as a reply envelope specific to that indicated recipient client application, or instead a reply envelope that corresponds to a group of multiple client applications that include the indicated recipient client application (e.g., to a client computing device on which the multiple client applications execute). The identified reply envelope may be a pending reply envelope that already includes one or more communications (e.g., communications from the same Web service that sent the current outgoing communication and/or from one or more other Web services provided by the server computing system). Alternatively, if a pending reply envelope does not currently exist for the indicated recipient client application (e.g., based on the current communication being a first communication to the indicated recipient client application, or instead based on a prior reply envelope for the indicated recipient client application having been recently dispatched to that client application), the routine in block 430 creates the identified reply envelope for the recipient client application.

In the illustrated embodiment, after block 430, the routine continues to block 435 to add the communication received in block 405 to the identified reply envelope, and then continues to block 440 to determine whether to currently assess whether to dispatch the current reply envelope to its recipient. For example, in some embodiments, the routine may determine to assess whether to dispatch a reply envelope at various times, such as after each communication is added to the reply envelope, or instead periodically. Alternatively, in some embodiments, the routine may determine to assess whether to dispatch a reply envelope based on another type of triggering event, such as based on current conditions satisfying one or more predefined dispatch determination initiation criteria (e.g., to reflect information about current resource usage of the server computing system; to reflect characteristics of a transmission medium over which communications are sent, such as signal strength related to a wireless connection, or network operational characteristics such as current bandwidth availability and/or network latency, etc.).

If it was instead determined in block 425 that the indication received in block 405 was not an outgoing communication, the routine continues instead to block 445 to determine whether an instruction was received in block 405 to initiate an assessment of whether to dispatch one or more current reply envelopes to their recipients, such as based on expiration of a timer to trigger a periodic assessment, or based on an indication of other current conditions that satisfy predefined dispatch determination initiation criteria. If so, the routine continues to block 450 to identify all of the pending reply envelopes for the server computing system (e.g., multiple reply envelopes that each correspond to one of multiple recipient client applications executing on multiple client computing devices), although in other embodiments only a subset of the pending reply envelopes may be considered (e.g., only reply envelopes of a particular type, only reply envelopes corresponding to particular recipients or types of recipients, only reply envelopes that are created before or after an indicated time, etc.). After block 450, or if it was determined in block 440 to currently assess the dispatch of the reply envelope identified in block 430, the routine continues to block 455 to determine whether it is appropriate to currently send any of the reply envelopes identified in blocks 430 or 450 to their recipients, and if so to select those reply envelopes for which it is determined to be appropriate. As discussed in greater detail elsewhere, a determination of whether it is appropriate to send a particular reply envelope at a particular time may be made in a variety of ways in various embodiments, such as based on whether current conditions satisfy one or more predefined dispatch criteria specific to the particular reply envelope and/or for use with all reply envelopes. Such predefined dispatch criteria may, for example, be based on information about a reply envelope (e.g., the amount of data in the envelope; the number of communications in the envelope; the length of time that the envelope has been pending, such as since a prior envelope to the same recipient was sent; etc.) and/or on other current conditions related to the server computing system, recipient client applications, and/or one or more transmission mediums to be used for sending one or more reply envelopes to one or more recipients. In the illustrated embodiment, the routine continues to block 460 to determine whether any of the identified reply envelopes were selected, and if so continues to block 465 to send each of the selected reply envelopes to the recipient client application for that reply envelope.

If it was instead determined in block 445 that the indication received in block 405 was not an instruction to currently assess whether to dispatch one or more pending reply envelopes, the routine continues instead to block 490 to perform one or more other indicated operations as appropriate. For example, in some embodiments, the routine may receive incoming communications that are not request envelopes, such as an individual request communication being sent to a specified Web service, and if so the routine may forward that received communication to the indicated recipient. Similarly, in some embodiments, at least some outgoing communications may be sent to at least some indicated recipients without aggregating the outgoing communications in a reply envelope, such as if the indicated recipient does not have a Client Communication Aggregation Manager system to de-aggregate such a reply envelope, or instead based on other information about the recipient, communication, and/or the transmission medium to be used for sending the communication. If so, such a received outgoing communication may be forwarded directly to the indicated recipient without aggregation in a reply envelope. A variety of other actions may similarly be taken in at least some embodiments with respect to block 490.

After blocks 420, 465, or 490, of if it is instead determined in block 440 not to currently assess whether to dispatch the current reply envelope, or in block 460 that none of the identified reply envelopes were selected, the routine continues to block 495 to determine whether to continue, such as to handle additional incoming and/or outgoing communications for the server computing system. If so, the routine returns to block 405, and if not continues to block 499 and ends.

Those skilled in the art will appreciate that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, synchronously or asynchronously, etc.) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A computer-implemented method for managing network communications between client applications and remote Web services, the method comprising:
under control of a client communication aggregation manager system that is executing on a mobile client computing device to manage communications to and from a plurality of client applications executing on the mobile client computing device,
receiving multiple outgoing request communications over a period of time, each of the request communications being sent from one of the executing client applications to an intended recipient that is one of multiple remote Web services each provided by one of multiple remote server computing systems;
creating multiple request envelopes that are each associated with one of the multiple remote server computing systems, each request envelope able to store multiple communications intended for one or more remote Web services provided by the associated remote server computing system;
for each of the received request communications,
identifying one of the created request envelopes that is associated with the remote server computing system providing the remote Web service that is the intended recipient for the request communication; and
adding the request communication to the identified request envelope in such a manner as to aggregate the added request communication with any other request communications that were previously added to the identified request envelope;
after the period of time, automatically determining at least one of the created request envelopes to currently send to the associated remote server computing system for the created request envelope, the determining being based at least in part on whether current conditions satisfy one or more predefined sending criteria, one of the determined created request envelopes storing an aggregation of multiple request communications that are from multiple of the plurality of client applications and that are intended for multiple of a plurality of Web services provided by one of the multiple remote server computing systems, at least some of the multiple request communications of the aggregation being unrelated to at least some other of the multiple request communications of the aggregation; and
sending each of the determined created request envelopes over one or more networks to the associated remote server computing system for the created request envelope; and
under control of a server communication aggregation manager system that is executing on the one remote server computing system to manage communications to and from the plurality of Web services provided by the one server computing system,
receiving the one determined request envelope sent by the client communication aggregation manager system executing on the mobile client computing device;
extracting the multiple request communications from the aggregation of the received request envelope; and
forwarding each of the extracted request communications to the Web service provided by the one server computing system that is the intended recipient of the extracted request communication,
so that a client computing device may aggregate multiple communications from multiple executing client applications and send the aggregated communications based on current conditions at a time of sending.

2. The method of claim 1 further comprising:
under control of the server communication aggregation manager system executing on the one remote server computing system, and after the forwarding of the request communications extracted from the received one determined request envelope,
receiving multiple outgoing reply communications that are each sent from one of the plurality of Web services provided by the one server computing system to an intended recipient that is one of the executing client applications on the mobile client computing device, one or more of the received outgoing reply communications each being a response to one or more of the forwarded request communications extracted from the received one determined request envelope, and one or more other of the received outgoing reply communications each being a response to one or more of request communications extracted from another request envelope received from the client communication aggregation manager system executing on the mobile client computing device;
adding the received multiple outgoing reply communications to an identified reply envelope for the mobile client computing device so as to create an aggregation of the received multiple outgoing reply communications; and
after it is automatically determined to send the identified reply envelope to the mobile client computing device, sending the identified reply envelope over one or more networks to the mobile client computing device; and
under control of the client communication aggregation manager system executing on the mobile client computing device, and after the sending of the identified reply envelope,
receiving the identified reply envelope sent by the server communication aggregation manager system executing on the one remote server computing system;
extracting the multiple reply communications from the aggregation of the received reply envelope; and
forwarding each of the extracted reply communications to the client application executing on the mobile client computing device that is the intended recipient of the extracted reply communication.

3. The method of claim 2 wherein the client communication aggregation manager system executing on the mobile client computing device further sends multiple other created request envelopes to the one remote server computing system, each of those multiple other created request envelopes including an aggregation of multiple additional outgoing request communications received by the client communication aggregation manager system during a distinct period of time, the multiple additional outgoing request communications for each of the other created request envelopes being sent from one or more of the executing client applications to intended recipients that include one or more of the plurality of Web services provided by the one remote server computing system, and wherein the server communication aggregation manager system executing on the one remote server computing system further receives each of the sent other created request envelopes, extracts the multiple additional request communications from the aggregations of each of the received other request envelopes, and forwards each of the extracted additional request communications to the Web service provided by the one server computing system that is the intended recipient of the extracted additional request communication.

4. The method of claim 3 wherein the method further comprises multiple other client communication aggregation manager systems that are executing on one of multiple other mobile client computing devices to manage communications to and from one or more client applications executing on that mobile client computing device, and multiple other server communication aggregation manager systems that are each executing on one of the multiple remote server computing systems to manage communications to and from one or more Web services provided by that remote server computing system, such that any of the client applications on the mobile computing client device and the multiple other mobile client computing devices may initiate outgoing request communications to any of the Web services provided by the multiple remote server computing systems, and such that each of the client communication aggregation manager systems maintains request envelopes for each of the multiple remote server computing systems so as to aggregate communications sent via the client communication aggregation manager system to the one or more Web services provided by the remote server computing system via the request envelope maintained for that remote server computing system.

5. A computer-implemented method for managing communications between client applications and remote network services, the method comprising:
under control of a client computing device,
receiving a plurality of outgoing request communications that are each initiated by one or more client applications executing on the client computing device and each intended for a recipient that is a network service remote from the client computing device, the plurality of outgoing request communications including multiple request communications whose intended recipients are one or more network services provided by a remote server computing system;
automatically creating a single request communication aggregation that includes the multiple request communications;
sending the single created request communication aggregation to the remote server computing system for forwarding of the multiple included request communications to the one or more provided network services;
after the sending of the single request communication aggregation, receiving a single reply communication aggregation from the remote server computing system that includes multiple incoming reply communications that are from the one or more provided network services and are each intended for at least one of the one or more executing client applications, the multiple reply communications including one or more reply communications that are each a response to one of the multiple request communications included in the sent single communication aggregation, the multiple reply communications further including one or more other reply communications that are responses to one or more other request communications included in one or more other communication aggregations sent by the client computing device to the remote server computing system; and
forwarding each of the multiple incoming reply communications to the at least one executing client application to which the incoming reply communication is intended.

6. The method of claim 5 wherein at least some of the multiple request communications included in the single created request communication aggregation are each requests from one of the one or more executing client applications for functionality to be provided by one of the one or more network services provided by a remote server computing system, and wherein at least one of the one or more included reply communications is a response to at least one of the at least some request communications, so as to provide the requested functionality for each of the at least one request communications to the executing client application that initiated the request communication.

7. The method of claim 6 wherein the at least some communications include multiple independent requests for distinct functionality to be provided by the one or more provided network services.

8. The method of claim 6 wherein each of the one or more network services provided by the remote server computing system is a Web service.

9. The method of claim 6 wherein the at least one request communications are each a request for information, wherein the at least one reply communications that are responses to the at least one request communications include the requested information, and wherein the providing of the requested functionality for each of the at least one request communications includes providing the requested information for the at least one request communication to the executing client application that initiated the request communication.

10. The method of claim 5 wherein the method is performed by a client communication management system executing on the client computing device.

11. The method of claim 10 wherein the one or more executing client applications are not configured to provide outgoing request communications to the executing client communication management system, and wherein the receiving of the plurality of outgoing request communications by the executing client communication management system includes intercepting the outgoing request communications after sent by the one or more executing client applications but before the sent outgoing request communications depart the client computing device.

12. The method of claim 5 wherein the single created request communication aggregation is part of a request envelope created by the client computing device, such that the sending of the single created request communication aggregation includes sending the request envelope.

13. The method of claim 5 wherein the single reply communication aggregation is part of a reply envelope created by the remote server computing system.

14. The method of claim 5 wherein the remote server computing system provides a plurality of distinct network services, and wherein the single created request communication aggregation includes request communications for multiple of the plurality of network services.

15. The method of claim 14 wherein the one or more client applications executing on the client computing device include a plurality of executing client applications, and wherein the single created request communication aggregation includes request communications from multiple of the plurality of executing client applications.

16. The method of claim 5 wherein the one or more client applications executing on the client computing device include a plurality of executing client applications, and wherein the single created request communication aggregation includes request communications from multiple of the plurality of executing client applications.

17. The method of claim 5 wherein the remote server computing system provides a plurality of distinct network services, and wherein the single request communication aggregation is created by the client computing device to be specific to one of the plurality of network services, such that the single created request communication aggregation includes request communications for the one network services.

18. The method of claim 5 wherein the remote server computing system provides a plurality of distinct network services, and wherein the client computing device further creates multiple request communication aggregations that are each specific to a subset of one or more of the plurality of network services, and independently sends each of the multiple created request communication aggregations to the server computing system.

19. The method of claim 5 further comprising, before the sending of the single created request communication aggregation, automatically determining to perform the sending based at least in part on one or more predefined criteria being determined to be satisfied.

20. The method of claim 19 wherein the automatic determining that the one or more predefined criteria are satisfied is based at least in part on one or more current conditions satisfying the one or more predefined criteria.

21. The method of claim 19 wherein the one or more predefined criteria are based at least in part on one or more of a current time, one or more current characteristics of the created request communication aggregation, one or more characteristics of resources being used by the client computing device, and one or more characteristics of one or more network connections via which the created request communication aggregation is to be sent to the remote server computing system.

22. The method of claim 19 wherein the one or more predefined criteria are specific to the single created request communication aggregation, such that other created request communication aggregations to be sent to other remote server computing systems have one or more other distinct predefined criteria.

23. The method of claim 5 wherein the client computing device is a mobile device, and wherein the sending of the single created request communication aggregation is performed based at least in part to conserve an amount of battery power for the mobile device.

24. The method of claim 23 wherein the client computing device uses a wireless data connection, and wherein the sending of the single created request communication aggregation is further performed based at least in part to enhance operational characteristics of the wireless data connection.

25. The method of claim 5 further comprising, under control of the client computing device, automatically creating multiple other request communication aggregations and sending the multiple other request communication aggregations to the remote server computing system, each of the other request communication aggregations including multiple request communications that are each initiated by at least one of the executing client applications and intended for at least one of the one or more network services provided by the remote server computing system.

26. The method of claim 25 wherein each of the other request communications is sent to the remote server computing system at a distinct time and includes communications initiated during a distinct period of time prior to the sending.

27. A computer-readable medium whose contents enable a client computing device to manage communications between client applications and remote network services, by performing a method comprising:
under control of a client communication management system of the client computing device,
receiving multiple outgoing request communications initiated by one or more client applications executing on the client computing device and intended for one or more recipient network services provided by a remote server computing system;
creating a single request communication aggregation that includes the multiple request communications; and
sending the single created request communication aggregation to the remote server computing system for forwarding of the multiple included request communications to the one or more provided network services.

28. The computer-readable medium of claim 27 wherein the method further comprises receiving multiple reply communications from the remote server computing system, such that at least one of the received reply communications is a response to one of the multiple request communications included in the sent request communication aggregation.

29. The computer-readable medium of claim 27 wherein the computer-readable medium is at least one of a memory of a computing device and a data transmission medium having a stored generated data signal containing the contents.

30. The computer-readable medium of claim 27 wherein the contents are instructions that when executed cause the computing device to perform the method.

31. A computing system configured to manage communications between client applications and remote network services, comprising:
a memory; and
a client communication management system that is configured to automatically manage communications for a client computing device, by:
receiving multiple outgoing communications initiated by one or more client applications executing on the client computing device and intended for one or more recipient network services provided by a remote server computing system;
sending to the remote server computing system a single created single communication aggregation that includes the multiple received communications;
receiving a single communication aggregation from the remote server computing system that includes multiple incoming communications from the one or more provided network services, such that a subset of the multiple incoming communications correspond to one or more of the multiple communications included in the sent single created communication aggregation; and
forwarding each of the multiple incoming communications to at least one of the executing client applications to which the incoming communication corresponds.

32. The computing system of claim 31 wherein the client communication management system is a client communication aggregation manager system that includes software instructions for execution by the computing system.

33. The computing system of claim 32 wherein the computing system is the client computing device, and further comprising software instructions of the one or more client applications for execution by the computing system.

34. The computing system of claim 31 wherein the client communication management system consists of a means for automatically managing communications for a client computing device, by:
receiving multiple outgoing communications initiated by one or more client applications executing on the client computing device and intended for one or more recipient network services provided by a remote server computing system;
sending to the remote server computing system a single created single communication aggregation that includes the multiple received communications;
receiving a single communication aggregation from the remote server computing system that includes multiple incoming communications from the one or more provided network services, such that a subset of the multiple incoming communications correspond to one or more of the multiple communications included in the sent single created communication aggregation; and
forwarding each of the multiple incoming communications to at least one of the executing client applications to which the incoming communication corresponds.

35. A computer-readable medium whose contents enable a server computing system to manage communications between client applications and network services, by performing a method comprising:
under control of a server communication management system of the server computing system,
receiving a plurality of incoming request communication aggregations that are each sent by one of multiple client computing devices, each of the incoming request communication aggregations including multiple request communications initiated by one or more client applications executing on the client computing device that sent the request communication aggregation, each included request communication intended for at least one of one or more network services provided by the server computing system, the received plurality of incoming request communication aggregations including multiple distinct request communication aggregations from one of the client computing devices;
forwarding the multiple request communications of each of the plurality of incoming request communication aggregations to the one or more provided network services to which the multiple request communications are intended;
receiving a plurality of outgoing reply communications that are each initiated by one of the one or more provided network services in response to at least one of the forwarded request communications of one of the plurality of incoming request communication aggregations, each outgoing reply communication intended for at least one executing client application on one of the client computing devices;
creating a single reply communication aggregation that includes multiple of the received plurality of outgoing reply communications that are intended for one or more executing client applications on the one client computing device, the multiple included reply communications in the reply communication aggregation including at least one reply communication that is a response to one or more request communications included in a first of the multiple request communication aggregations from the one client computing device, and the included reply communications in the reply communication aggregation including at least one other reply communication that is a response to one or more other request communications included in a distinct second of the multiple request communication aggregations from the one client computing device; and
sending the single created reply communication aggregation to the one client computing device for forwarding of the multiple included reply communications to the one or more executing client applications on the one client computing device.
